(19) United States
(12) Patent Application Publication
(10) Pub. No.: US 2023/0177454 A1
(43) Pub. Date: Jun. 8, 2023

(54) PATH-BASED JOINT ORDERING APPLICATION DEVICE AND PATH-BASED JOINT ORDERING SYSTEM INCLUDING THE SAME

(71) Applicant: University of Seoul Industry Cooperation Foundation, Seoul (KR)

(72) Inventor: Chulmin JUN, Seoul (KR)

(21) Appl. No.: 18/076,377

(22) Filed: Dec. 6, 2022

(30) Foreign Application Priority Data
Dec. 8, 2021 (KR) 10-2021-0175228

(51) Int. Cl. G06Q 10/0835; G06Q 10/087

(52) U.S. Cl. CPC G06Q 10/08355; G06Q 10/087

(57) ABSTRACT

Provided are a path-based joint ordering application device, which may reduce the cost incurred for delivery by allowing one deliverer to deliver delivery services ordered by many users.

The device includes: an order room creating unit created by a host terminal and creating an order room including an order condition for requesting a delivery service to an franchise terminal; a guest determining unit determining whether ordering information of a guest terminal participating in the order room for joint ordering satisfies the order condition; an ordering information creating unit creating joint ordering information by merging ordering information input from the host terminal and the ordering information input from the guest terminal when the ordering information of the guest terminal satisfies the order condition; and a delivery path creating unit creating a delivery path connecting all of pieces of location information of the franchise terminal, the host terminal, and the guest terminal.

### CROSS REFERENCE TO RELATED APPLICATION

The present application claims priority to Korean Patent Application No. 10-2021-0175228, filed on Dec. 8, 2021, the entire contents of which are incorporated herein for all purposes by this reference.

### TECHNICAL FIELD

The present disclosure relates to a path-based joint ordering application device and a path-based joint ordering system including the same, which may reduce the cost incurred for delivery by allowing one delivery person to deliver delivery services ordered by a plurality of users.

### BACKGROUND

Home deliveries are rapidly increasing. In particular, delivery orders have increased even more in the recent pandemic situation caused by COVID-19.

A typical delivery order method is a method in which one delivery person is assigned to one orderer. This is equally applied to a plurality of orderers residing in adjacent areas, resulting in an increase in delivery costs, and there is a problem in that the overall social cost caused by repeatedly delivering similar paths increases.

### SUMMARY

In view of the above, the present disclosure provides a path-based joint ordering application device and a path-based joint ordering system including the same, which may reduce the cost incurred for delivery by allowing one delivery person to deliver delivery services ordered by a plurality of users.

A path-based joint ordering application device according to an embodiment of the present disclosure includes: an order room creating unit created by a host terminal and creating an order room including an order condition for requesting a delivery service to an franchise terminal; a guest determining unit determining whether ordering information of a guest terminal participating in the order room for joint ordering satisfies the order condition; an ordering information creating unit creating joint ordering information by merging ordering information input from the host terminal and the ordering information input from the guest terminal when the ordering information of the guest terminal satisfies the order condition; and a delivery path creating unit creating a delivery path connecting all of pieces of location information of the franchise terminal, the host terminal, and the guest terminal.

In the path-based joint ordering application device according to an embodiment of the present disclosure, the order condition may include an opening holding time of the order room and a required delivery time set by the host terminal.

In the path-based joint ordering application device according to an embodiment of the present disclosure, the guest determining unit may add a delivery path for the guest terminal to a delivery path for the host terminal, and determine that the ordering information of the guest terminal satisfies the order condition when a required delivery time according to a joint delivery path created using a shortest path search algorithm is within a required delivery time set by the host terminal.

In the path-based joint ordering application device according to an embodiment of the present disclosure, the ordering information creating unit may calculate a total delivery cost by adding the additional delivery cost for the guest terminal participating in the order room to the basic delivery cost, calculate the additional delivery cost by reducing the basic delivery cost by a preset ratio, and calculate an allocated individual delivery cost by dividing the total delivery cost according to the number of host terminal and the guest terminals and includes the individual delivery cost in the joint ordering information.

In the path-based joint ordering application device according to an embodiment of the present disclosure, the individual delivery cost may be divided differentially according to a delivery order or delivery distance or delivery time included in the delivery path created by the delivery path creating unit.

In the path-based joint ordering application device according to an embodiment of the present disclosure, the delivery path connecting the franchise and all participating orderers may be a shortest path in terms of distance or a shortest path in time reflecting road traffic conditions.

A path-based joint ordering application system according to an embodiment of the present disclosure includes a user terminal equipped with an application including an order room creating unit created by a host terminal and creating an order room including an order condition for requesting a delivery service to an franchise terminal, a guest determining unit determining whether ordering information of a guest terminal participating in the order room for joint ordering satisfies the order condition, an ordering information creating unit creating joint ordering information by merging ordering information input from the host terminal and the ordering information input from the guest terminal when the ordering information of the guest terminal satisfies the order condition, and a delivery path creating unit creating a delivery path connecting all of pieces of location information of the franchise terminal, the host terminal, and the guest terminal; an franchise terminal providing products according to the joint ordering information; a delivery service platform receiving joint ordering information from the user terminal and transmitting the joint ordering information to the franchise terminal; and a delivery person terminal moving to the franchise according to an instruction of the delivery service platform to receive the products according to the joint ordering information, and providing a delivery service to a recipient of the user terminal while moving along a delivery path included in the joint ordering information.

Other details of implementations according to various aspects of the invention are included in the detailed description below.

According to an embodiment of the present disclosure, delivery services ordered by a plurality of users may be delivered by a single delivery person, thereby reducing the cost required for delivery to reduce the burden on consumers, and also, since the delivery person may provide multiple delivery services by one delivery, he/she may earn more in the delivery service to get financial benefits. As a result, the cost of the delivery services may be reduced as a whole.

### BRIEF DESCRIPTION OF THE DRAWINGS

FIG. 1 is a conceptual diagram illustrating a path-based joint ordering system according to an embodiment of the present disclosure.

FIG. 2 is a diagram illustrating a path-based joint ordering system including a path-based joint ordering application device according to an embodiment of the present disclosure.

FIG. 3 is a diagram illustrating a path-based joint ordering application device according to an embodiment of the present disclosure.

FIG. 4 is a diagram illustrating an order room as a user interface provided by a path-based joint ordering application device according to an embodiment of the present disclosure.

FIGS. 5, 6A, 6B, 7A, 7B, 7C, 7D, 7E, and 7F are views illustrating a process of determining guest eligibility using the shortest path search algorithm.

FIG. 8 is a diagram illustrating a computing device according to an embodiment of the present disclosure.

### DETAILED DESCRIPTION

As the inventive concept allows for various changes and numerous embodiments, particular embodiments will be illustrated in the drawings and described in detail in the written description. However, this is not intended to limit the inventive concept to particular modes of practice, and it is to be appreciated that all changes, equivalents, and substitutes that do not depart from the scope of the inventive concept are encompassed in the inventive concept.

The terms used in the application are used to describe specific embodiments only and are not intended to limit the present disclosure. A singular expression includes a plural expression as long as they are clearly distinguished in the context. In the application, it should be understood that the terms such as “comprising”, “including” are intended to express that features, numbers, steps, operations, constituent elements, part, or combinations thereof described in the specification are present and do not exclude existence or additions of one or more other features, numbers, steps, operations, constituent elements, part, or combinations thereof. Hereinafter, a path-based joint ordering application device and a path-based joint ordering system including the same according to an embodiment of the present disclosure will be described with reference to the accompanying drawings.

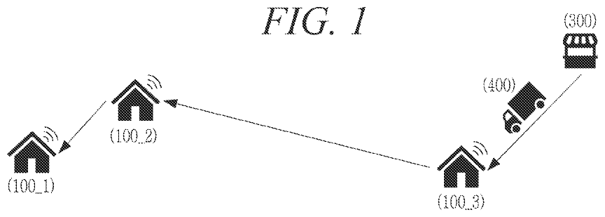

FIG. 1 is a conceptual diagram illustrating a path-based joint ordering system according to an embodiment of the present disclosure.

As shown in FIG. 1, in a path-based joint ordering system according to an embodiment of the present disclosure, when users of guest terminals 100_2 and 100_3 participate in an order room opened by a user of a host terminal 100_1 to create joint ordering information and jointly request a delivery service, a delivery person owning a deliverer terminal 400 may provide a delivery service to a recipient of all the user terminals 100_1, 100_2, and 100_3, while moving along a delivery path created in the joint ordering information, and each provide delivery service.

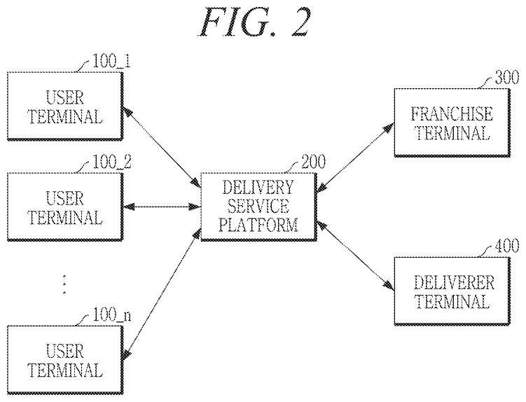

FIG. 2 is a diagram illustrating a path-based joint ordering system including a path-based joint ordering application device according to an embodiment of the present disclosure.

As shown in FIG. 2, the path-based joint ordering system according to an embodiment of the present disclosure includes the user terminal (100: 100_1, 100_2, . . . , 100_n), a delivery service platform 200, a franchise terminal 300, and the deliverer terminal 400.

A path-based joint ordering application device (hereinafter, referred to as an ‘application device’) according to an embodiment of the present disclosure may be downloaded from a server (Google Play Store, Apple App Store, etc.) that provides various applications and loaded to mobile terminals such as a smartphone, tablet, or laptop computer or a desktop computer to be used. Such mobile terminals, such as a smartphone, a tablet, or a laptop computer or a desktop computer equipped with the application device are referred to as the user terminal (100: 100_1, 100_2, . . . , 100_n).

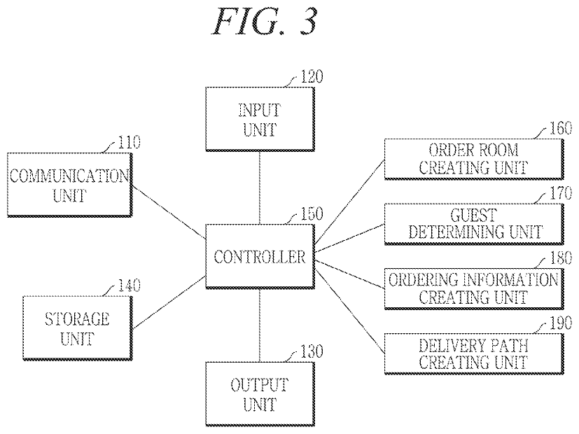

The user terminal 100: 100_1, 100_2, . . . , 100_n creates joint ordering information including a single delivery path by way of all delivery destinations of joint orderers and transmits the created joint ordering information to the delivery service platform 200. A plurality of user terminals may jointly create ordering information for a specific franchise. This will be described later with reference to FIG. 3.

The delivery service platform 200 transmits and receives various information (ordering information, delivery information, etc.) while performing data communication with the user terminal 100, the franchise terminal 300, and the deliverer terminal 400. The delivery service platform 200 receives the joint ordering information from the user terminal 100 and transmits the received joint ordering information to the franchise terminal 300 and the deliverer terminal 400, and receives delivery information such as a delivery path, an arrival time, etc. from the franchise terminal 300 and the deliverer terminal 400 and transmits the received delivery information to the user terminal 100.

The franchise terminal 300 receives ordering information from the delivery service platform 200, and when a product (food) according to the ordering information is delivered, the franchise terminal 300 transmits delivery information such as an arrival time to the delivery service platform 200. In some cases, the delivery information may be directly transmitted to the user terminal 100 without going through the delivery service platform 200.

The deliverer terminal 400 moves to a franchise according to the instructions of the delivery service platform 200 to receive food according to the joint ordering information, and provides a delivery service to each recipient of all the user terminals 100_1, 100_2, and 100_3, while moving along the delivery path included in the joint ordering information. When the delivery service is completed, the deliverer terminal 400 notifies the delivery service platform 200 that delivery is completed.

FIG. 3 is a diagram illustrating a path-based joint ordering application device according to an embodiment of the present disclosure.

As shown in FIG. 3, the application device of the present disclosure includes a communication unit 110, an input unit 120, an output unit 130, a storage unit 140, a controller 150, an order room creating unit 160, a guest determining unit 170, an ordering information creating unit 180, and a delivery path creating unit 190.

The communication unit 110 performs a function for transmitting and receiving data through a communication network. The communication unit 110 communicates with an external device (the delivery service platform 200, the franchise terminal 300, the deliverer terminal 400) through an antenna of a mobile terminal or the like.

The input unit 120 receives various information such as number and character information, and transmits input signals related to setting various functions and controlling functions of the application device to the controller 180. In addition, the input unit 120 may be configured to include at least one of a keypad and a touchpad that generate an input signal according to a user's touch or operation. In this case, the input unit 120 may be configured in the form of a single touch panel (or touch screen) together with the output unit 130 to simultaneously perform input and display functions. Also, the input unit 120 may include a microphone performing voice input.

The output unit 130 may output a user interface corresponding to a user input. The output unit 130 may display a menu of the application device, user data input by the user, and the like. When the output unit 130 is configured as a touch screen, the output unit 130 may perform some or all of the functions of the input unit 120.

The storage unit 140, a device for storing data, may include a main storage device and an auxiliary storage device and may store an application program required for a functional operation of the application device.

The controller 150 controls to process all operations of the application device. That is, the controller 150 controls operations of each of the communication unit 110, the input unit 120, the output unit 130, the storage unit 140, the order room creating unit 160, the guest determining unit 170, and the ordering information creating unit 180, and the delivery path creating unit 190.

Functions of the communication unit 110, the input unit 120, the output unit 130, the storage unit 140, the controller 150 and the order room creating unit 160, the guest determining unit 170, the ordering information creating unit 180, and the delivery path creating unit 190 may be performed by each element of a terminal (mobile terminal, desktop PC, etc.) in which the application device of the present disclosure is loaded.

At least one of the user terminals 100: 100_1, 100_2, . . . , 100_n of FIG. 2 may be a host terminal, and the rest may be guest terminals. Of course, any one user terminal may serve as both a host terminal and a guest terminal. In this specification, the user terminal 100 is used as a generic term for a host terminal and a guest terminal.

The host terminal is a terminal of a user who opens an order room, and the guest terminal is a terminal of a user participating in the order room opened by the host terminal for joint ordering. In this specification, for convenience of description, it is assumed that the user terminal 100_1 is a host terminal and the other terminals are guest terminals.

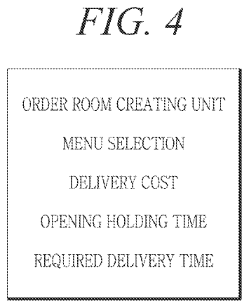

FIG. 4 is a diagram illustrating an order room as a user interface provided by a path-based joint ordering application device according to an embodiment of the present disclosure.

The order room creating unit 160 provides an order room including order conditions for requesting a delivery service to the franchise terminal 300. The user of the host terminal 100_1 may select “Order Room Creation” from an interface provided by the application device of the present disclosure to create an order room as illustrated in FIG. 4.

The host terminal user (hereinafter, referred to as a ‘host’) selects a franchise (restaurant) in the “Franchise Information” field, and selects a menu (food) to order from the corresponding franchise in “Menu Selection”.

In addition, the host sets a time range for which the order room is opened and maintained in an “Opening holding time” field. The opening holding time may be directly entered by the user or selected by scrolling. For example, the opening holding time may be 30 minutes. During the opening holding time, the user of the guest terminals 100_2, . . . , 100_n may participate in the order room.

In addition, the host sets a time range for completing delivery of orders of all orderers including the host and guest in a “Required Delivery Time” field. For example, the required delivery time may be 30 minutes.

Here, the franchise information, the opening holding time, and the required delivery time correspond to order conditions required for the joint ordering. The franchise information may be a franchise name, location information of a franchise (franchise terminal), and the like.

When the order room is opened, only the host is an orderer, so a basic delivery cost is displayed in a “Delivery Cost” field.

A guest terminal user (hereinafter referred to as a ‘guest’) may participate in the order room created by the host during the opening holding time set by the host. Of course, there may be a plurality of order rooms, and the guest may select an order room in which a desired franchise is displayed.

The guest participating during the opening holding time select a menu (food) they want to order from the franchise in the menu selection field.

According to guest participation, a total delivery cost is calculated and displayed in the delivery cost field by adding an additional delivery cost to the basic delivery cost. In this case, the additional delivery cost is calculated by reducing the basic delivery cost by a preset ratio. As the number of guests increases, the preset ratio may increase. That is, as the number of orderers (total number of hosts and guests) increases, the additional delivery cost may gradually decrease.

The guest determining unit 170 determines whether the ordering information of the guest participating in the order room satisfies an order condition set by the host.

Based on the opening holding time set by the host as a closing time from the order room opening time by the host, if the guest participates after the opening holding time, the guest determining unit 170 may deactivate the menu selection field so that the guest cannot select the menu selection.

Although the guest participates within the opening holding time, if the required delivery time increased due to the joint ordering participation of the corresponding guest exceeds the required delivery time set by the host, the guest determining unit 170 may exclude the corresponding guest from the joint orderers.

Specifically, the guest determining unit 170 creates at least one joint delivery path using the shortest path search algorithm and calculates a required delivery time according to the created joint delivery path, and if the calculated delivery time is within the required delivery time set by the host, the guest determining unit 170 determines that the guest's ordering information satisfies the order condition.

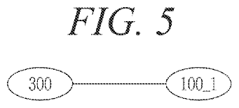

This will be described with reference to FIGS. 5 to 7. FIGS. 5 to 7 are views illustrating a process in which the guest determining unit 170 determines guest eligibility using the shortest path search algorithm.

First, in FIG. 5, only the host 100_1 orders. In FIGS. 5 to 7, there may be a plurality of delivery paths as the paths from the franchise 300 to the host 100_1 and the guests 100_2 and 100_3, but only one path is illustrated for convenience of description.

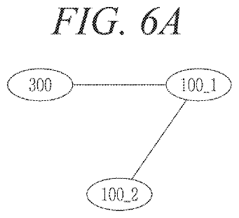

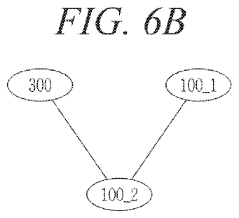

Next, FIGS. 6A and 6B show a case in which the first guest 100_2 participates. The guest determining unit 170 creates a joint delivery path due to the participation of the first guest 100_2 in an existing delivery path (FIG. 5) using the shortest path search algorithm. The shortest path search algorithm may be any one of currently known Dijkstra's Algorithm,

A* Search Algorithm, Bellman-Ford Algorithm, Floyd-Warshall Algorithm, Shortest Path Faster Algorithm (SPFA), and the like.

The guest determining unit 170 creates a joint delivery path of franchise→host→first guest as shown in FIG. 6A or a joint delivery path of franchise→first guest→host as shown in FIG. 6B. The guest determining unit 170 calculates a required delivery time for each path and determines a path within the required delivery time set by the host as a joint delivery path. Of course, this is not a final decision, and if another guest is added during the opening holding time, the guest determining unit 170 recreates a joint delivery path in consideration of the added guest, recalculates a required delivery time, and determines a path within the required delivery time set by the host, as a joint delivery path.

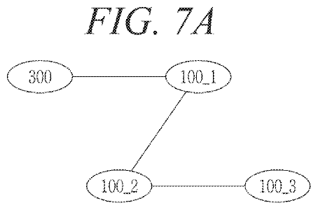

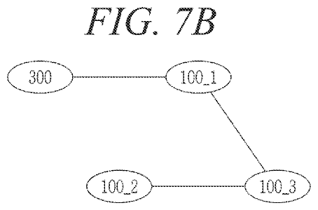

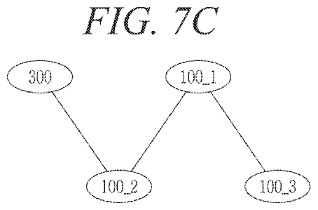

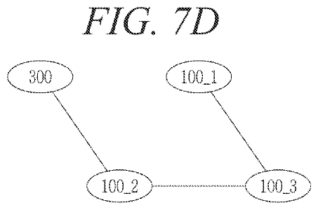

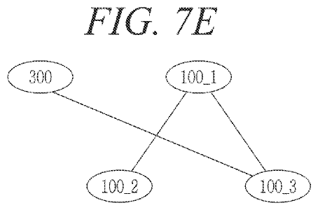

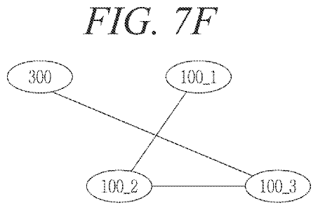

That is, when the first guest 100_2 and the second guest 100_3 participate during the opening holding time, the guest determining unit 170 creates joint delivery paths leading to the host and all guests as shown in FIGS. 7A to 7F.

The guest determining unit 170 calculates the required delivery time for each joint delivery path illustrated in FIGS. 7A to 7F and determines a path within the required delivery time set by the host as a joint delivery path. For example, when FIGS. 7C and FIG. 7F satisfy the required delivery time set by the host, the guest determining unit 170 determines the corresponding paths as joint delivery paths. In this case, the guest determining unit 170 may determine that a path requiring less delivery time as a final joint delivery path.

If the required delivery time according to the all re-created joint delivery paths exceeds the required delivery time set by the host due to the participation of the second guest 100_3, the guest determining unit 170 determines that the second guest 100_3 is not eligible, and excludes the second guest 100_3 from joint orderers.

The ordering information creating unit 180 creates joint ordering information by merging the ordering information selected by the host terminal and the ordering information selected by the guest terminal. The ordering information selected by the host terminal may include a franchise name, a food (product) menu, and the like. The ordering information selected by the guest terminal may include a food (product) menu and the like (franchises are the same).

The ordering information creating unit 180 may calculate a total delivery cost according to the number of hosts and guests. The ordering information creating unit 180 may calculate the total delivery cost by adding an additional delivery cost according to the number of people to a basic delivery cost (delivery cost per person). The additional delivery cost may be calculated by reducing the basic delivery cost per person by a certain ratio. The ordering information creating unit 180 may calculate an individual delivery cost allocated by dividing the total delivery cost according to the number of hosts and guests, and may include the calculated delivery cost in the joint ordering information.

For example, assuming that a delivery cost is 3,000 won when ordering for one person, if there are three joint orderers including the host, the total delivery cost may usually be 9,000 won, but according to the present disclosure, the delivery cost is calculated as “Basic delivery cost of 3,000 won per person+2,000 won per additional person+1,000 won per another additional person”, so that the total delivery cost may be calculated as 6,000 won and the individual delivery cost may be calculated as 2,000 won.

In the above, the individual delivery cost is calculated by equally dividing the total delivery cost by the number of people, but the present disclosure is not limited thereto and the individual delivery cost may be differentially calculated according to a weighting factor. The weighting factor may be whether a terminal is the host terminal and a temporal order of the guest terminals participating in the order room opened by the host terminal. Alternatively, the weighting factor may be a delivery order, or a delivery distance, or a delivery time.

The ordering information creating unit 180 may calculate the individual delivery cost of the host terminal as a minimum cost, and calculate the individual delivery cost of the guest terminal preceding in the participation order to be smaller than the individual development cost of the guest terminal subsequent in the participation order. In this manner, by giving merits to the guest who participates in the order room earlier, and motivating the guest to wait during a waiting time, the activation of the order room may be promoted. In this case, in the above example in which the total delivery cost is 6,000 won, the ordering information creating unit 180 may calculate the individual delivery costs as 1,500 won for the host, 2,000 won for the first guest, and 2500 won for the second guest.

The delivery path creating unit 190 creates a joint delivery path via all of, the location of the franchise terminal, the location of the host terminal, and the locations of the guest terminals processed to be eligible as joint orderers. The joint delivery path is a delivery path connecting the franchise, the host, and all the guests, and may be the shortest path in terms of distance or the shortest path in time reflecting road traffic conditions.

As described above, according to the path-based joint ordering application device and the path-based joint ordering system including the same according to an embodiment of the present disclosure, delivery services ordered by a plurality of users may be delivered by a single delivery person, so that costs incurred for delivery may be reduced to reduce the burden on the consumers, and also, since the delivery person may provide multiple delivery services by one delivery, he/she may earn more in the delivery service to get financial benefits. As a result, the cost of the delivery services may be reduced as a whole.

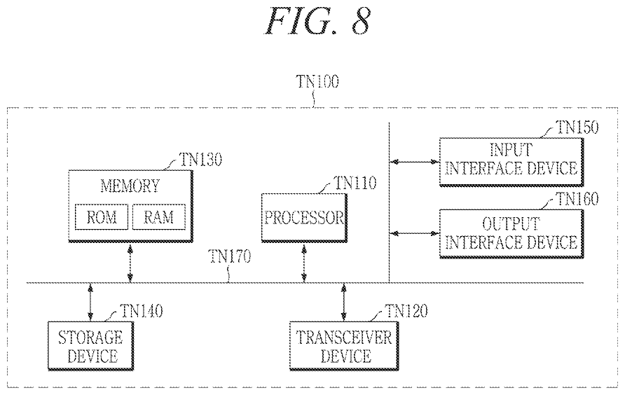

FIG. 8 is a diagram illustrating a computing device according to an embodiment of the present disclosure. A computing device TN100 of FIG. 8 may be a device described herein (e.g., a user terminal, a delivery service platform, a franchise terminal, a deliverer terminal, etc.).

In the embodiment of FIG. 8, the computing device TN100 may include at least one processor TN110, a transceiver device TN120, and a memory TN130. Also, the computing device TN100 may further include a storage device TN140, an input interface device TN150, an output interface device TN160, and the like. The components included in the computing device TN100 may be connected by a bus TN170 to communicate with each other.

The processor TN110 may execute a program command stored in at least one of the memory TN130 and the storage device TN140. The processor TN110 may refer to a central processing unit (CPU), a graphics processing unit (GPU), or a dedicated processor on which the methods according to an embodiment of the present disclosure are performed. The processor TN110 may be configured to implement procedures, functions, and methods described in connection with an embodiment of the present disclosure. The processor TN110 may control each component of the computing device TN100.

Each of the memory TN130 and the storage device TN140 may store various information related to the operation of the processor TN110. Each of the memory TN130 and the storage device TN140 may be configured as at least one of a volatile storage medium and a nonvolatile storage medium. For example, the memory TN130 may include at least one of a read only memory (ROM) and a random access memory (RAM).

The transceiver device TN120 may transmit or receive a wired signal or a wireless signal. The transceiver device TN120 may be connected to a network to perform communication.

Meanwhile, the present disclosure may be implemented as a computer program. The present disclosure may be implemented as a computer program stored in a computer-readable recording medium in combination with hardware.

The methods according to an embodiment of the present disclosure may be implemented in the form of a program readable by various computer means and recorded in a computer-readable recording medium. Here, the recording medium may include a program command, a data file, a data structure, etc. alone or in combination.

The program commands recorded in the recording medium may be specially designed and configured for the present disclosure or may be known and available to those skilled in the art of computer software.

For example, the recording medium includes magnetic media such as hard disks, floppy disks and magnetic tapes, optical recording media such as CDROM and DVD, and magneto-optical media such as floppy disks, and hardware devices specially configured to store and execute program commands, such as ROM, RAM, flash memory, and the like.

Examples of the program commands may include not only machine language such as created by a compiler but also a high-level language that may be executed by a computer using an interpreter or the like.

Such hardware devices may be configured to operate as one or more software modules to perform the operations of the present disclosure, and vice versa.

Although the embodiments of the present disclosure have been described hereinabove, those skilled in the art will appreciate that various changes and modifications may be made to the embodiments described herein by the addition, modification, removal and the like of elements without departing from the scope and spirit of the present disclosure as disclosed in the appended claims, and the various changes and modifications are to be construed as being included within the right scope of the present disclosure.

[Detailed Description of Main Elements]

| | |
|---|---|
| 100: user terminal | |
| 100_1: host terminal | 100_2~100_n: guest terminal |
| 110: communication unit | 120: input unit |
| 130: output unit | 140: storage unit |
| 150: controller | 160: order room creating unit |
| 170: guest determining unit | 180: ordering information creating unit |
| 190: delivery path creating unit | |
| 200: delivery service platform | |
| 300: franchise terminal | |
| 400: delivery person terminal | |

What is claimed is:

1. A path-based joint ordering application device comprising:
an order room creating unit created by a host terminal and creating an order room including an order condition for requesting a delivery service to an franchise terminal;
a guest determining unit determining whether ordering information of a guest terminal participating in the order room for joint ordering satisfies the order condition;
an ordering information creating unit creating joint ordering information by merging ordering information input from the host terminal and the ordering information input from the guest terminal when the ordering information of the guest terminal satisfies the order condition; and
a delivery path creating unit creating a delivery path connecting all of pieces of location information of the franchise terminal, the host terminal, and the guest terminal.

2. The path-based joint ordering application device of claim 1, wherein
the order condition includes an opening holding time of the order room and a required delivery time set by the host terminal.

3. The path-based joint ordering application device of claim 2, wherein
the guest determining unit adds a delivery path for the guest terminal to a delivery path for the host terminal, and determines that the ordering information of the guest terminal satisfies the order condition when a required delivery time according to a joint delivery path created using a shortest path search algorithm is within a required delivery time set by the host terminal.

4. The path-based joint ordering application device of claim 1, wherein
the ordering information creating unit calculates a total delivery cost by adding the additional delivery cost for the guest terminal participating in the order room to the basic delivery cost,
calculates the additional delivery cost by reducing the basic delivery cost by a preset ratio, and
calculates an allocated individual delivery cost by dividing the total delivery cost according to the number of host terminal and the guest terminal and includes the individual delivery cost in the joint ordering information.

5. The path-based joint ordering application device of claim 4, wherein
the individual delivery cost is divided differentially according to a delivery order or delivery distance or delivery time included in the delivery path created by the delivery path creating unit.

6. The path-based joint ordering application device of claim 1, wherein
the delivery path is a shortest path in terms of distance or a shortest path in time reflecting road traffic conditions.

7. A path-based joint ordering application system comprising:
a user terminal equipped with an application including an order room creating unit created by a host terminal and creating an order room including an order condition for requesting a delivery service to an franchise terminal, a guest determining unit determining whether ordering information of a guest terminal participating in the order room for joint ordering satisfies the order condition, an ordering information creating unit creating joint ordering information by merging ordering information input from the host terminal and the ordering information input from the guest terminal when the ordering information of the guest terminal satisfies the order condition, and a delivery path creating unit creating a delivery path connecting all of pieces of location information of the franchise terminal, the host terminal, and the guest terminal;
an franchise terminal providing products according to the joint ordering information;
a delivery service platform receiving joint ordering information from the user terminal and transmitting the joint ordering information to the franchise terminal; and
a delivery person terminal moving to the franchise according to an instruction of the delivery service platform to receive the products according to the joint ordering information, and providing a delivery service to a recipient of the user terminal while moving along a delivery path included in the joint ordering information.

8. The path-based joint ordering application system of claim 7, wherein
the order condition includes an opening holding time of the order room and a required delivery time set by the host terminal.

9. The path-based joint ordering application system of claim 8, wherein
the guest determining unit adds a delivery path for the guest terminal to a delivery path for the host terminal, and determines that the ordering information of the guest terminal satisfies the order condition when a required delivery time according to a joint delivery path created using a shortest path search algorithm is within a required delivery time set by the host terminal.

10. The path-based joint ordering application system of claim 7, wherein
the ordering information creating unit calculates a total delivery cost by adding the additional delivery cost for the guest terminal participating in the order room to the basic delivery cost,
calculates the additional delivery cost by reducing the basic delivery cost by a preset ratio, and
calculates an allocated individual delivery cost by dividing the total delivery cost according to the number of host terminal and the guest terminal and includes the individual delivery cost in the joint ordering information.

11. The path-based joint ordering application system of claim 10, wherein
the individual delivery cost is divided differentially according to a delivery order or delivery distance or delivery time included in the delivery path created by the delivery path creating unit.

12. The path-based joint ordering application system of claim 7, wherein
the delivery path is a shortest path in terms of distance or a shortest path in time reflecting road traffic conditions.
